(19) United States
(12) Patent Application Publication
(10) Pub. No.: US 2026/0287563 A1
(43) Pub. Date: Sep. 24, 2026

(54) ANALYSIS SYSTEM, CONTROL METHOD THEREOF, AND RECORDING MEDIUM

(71) Applicant: SHIMADZU CORPORATION, Kyoto-shi, Kyoto (JP)

(72) Inventors: Yuka FUJITO, Kyoto-shi, Kyoto (JP); Timothy LEE, Columbia, MD (US)

(73) Assignee: SHIMADZU CORPORATION, Kyoto-shi, Kyoto (JP)

(21) Appl. No.: 19/475,503

(22) PCT Filed: Mar. 21, 2024
(86) PCT No.: PCT/JP2024/010994

§ 371 Date: Oct. 15, 2025

Related U.S. Application Data
(60) Provisional application No. 63/459,714, filed on Apr. 17, 2023.

(51) Int. Cl. G01N 30/46; B01D 15/10; B01D 15/18; B01D 15/20; B01D 15/42; G01N 30/86

(52) U.S. Cl. CPC G01N 30/46; B01D 15/102; B01D 15/1878; B01D 15/203; B01D 15/424; G01N 30/8665

(57) ABSTRACT

An analysis system (100) includes a first column (50) that traps a sample, a first supply unit (20) that supplies one or more types of fluids to the first column (50), a storage unit (60) that stores an elution solvent, a second column (80) to which one or more components primarily separated in the first column are introduced, a second supply unit (90) that supplies a mobile phase for secondary separation to the second column (80), and a controller (10) that controls the first supply unit (20) and the second supply unit (90). The controller (10), as an initialization of the analysis system (100), performs washing the first column (50), supplying the mobile phase to the second column (80), storing the elution solvent in the storage unit (60), and equilibrating the first column (50) with a trapping solvent.

### TECHNICAL FIELD

The present invention relates to an analysis system including a plurality of columns.

### BACKGROUND ART

Conventionally, various proposals have been made regarding a technique called multidimensional chromatography, which uses a combination of a plurality of columns. For example, Japanese Patent No. 4,609,494 (Patent Literature 1) discloses a technique for reducing the number of trap columns that trap components separated by a first-dimension analysis column in two-dimensional chromatography.

### CITATION LIST PATENT LITERATURE

Patent Literature 1: Japanese Patent No. 4,609,494

### SUMMARY OF INVENTION

### Technical Problem

In an analysis system that implements two-dimensional chromatography, the details of the initialization performed at startup have not been established. Therefore, the user of the analysis system has been required to consider the details of the initialization.

The present invention has been devised in view of such circumstances, and an object thereof is to provide a technique for reducing the burden on the user regarding the initialization of an analysis system that implements two-dimensional chromatography.

### Solution to Problem

An analysis system according to an aspect of the present disclosure includes a first column that traps a sample, and a first supply unit that supplies one or more types of fluids to the first column, wherein the one or more types of fluids include a washing liquid, a trapping solvent for trapping the sample in the first column, and an elution solvent for primary separation of the sample trapped in the first column, a storage unit that stores the elution solvent, a second column to which one or more components primarily separated by the first column are introduced, a second supply unit that supplies a mobile phase for secondary separation to the second column, and a controller that controls the first supply unit and the second supply unit, wherein the controller, as an initialization of the analysis system, performs washing the first column, supplying the mobile phase to the second column, storing the elution solvent in the storage unit, and equilibrating the first column with the trapping solvent.

A control method for an analysis system according to another aspect of the present disclosure is implemented by a computer, wherein the analysis system includes a first column that traps a sample, and a first supply unit that supplies one or more types of fluids to the first column, wherein the one or more types of fluids include a washing liquid, a trapping solvent for trapping the sample in the first column, and an elution solvent for primary separation of the sample trapped in the first column, a storage unit that stores the elution solvent, a second column to which one or more components primarily separated by the first column are introduced, and a second supply unit that supplies a mobile phase for secondary separation to the second column, and the control method, as an initialization of the analysis system, comprises washing the first column, supplying the mobile phase to the second column, storing the elution solvent in the storage unit, and equilibrating the first column with the trapping solvent.

A recording medium according to yet another aspect of the present disclosure is a computer-readable recording medium non-transitorily storing a program, wherein the program, when executed by one or more processors of a computer of the analysis system, causes the computer to implement the control method described above.

### Advantageous Effects of Invention

The above and other objects, features, aspects, and advantages of the present invention will become apparent from the following detailed description of the present invention when understood in conjunction with the accompanying drawings.

### BRIEF DESCRIPTION OF DRAWINGS

FIG. 1 is a schematic configuration diagram of an analysis system 100 according to an embodiment of the present disclosure.

FIG. 2 is a diagram for explaining the operation during period A.

FIG. 3 is a diagram for explaining the operation during period B.

FIG. 4 is a diagram for explaining the operation during period C.

FIG. 5 is a diagram for explaining the operation during period D.

FIG. 6 is a diagram for explaining the operation during period E.

FIG. 7 is a diagram for explaining the operation during period F.

FIG. 8 is a diagram for explaining the operations of the liquid-sending unit 20 and the second liquid-sending unit 90 during periods A to F.

FIG. 9 is a flowchart of an example of processing performed in the analysis system 100.

FIG. 10 is a flowchart of a subroutine of step S10 in FIG. 9.

FIG. 11 is a flowchart of a subroutine of step S30 in FIG. 9.

FIG. 12 is a flowchart of a process (error handling process) performed in parallel with the process of FIG. 9.

FIG. 13 is a diagram showing a modification of FIG. 12.

### DESCRIPTION OF EMBODIMENTS

Hereinafter, embodiments of the present disclosure will be described in detail with reference to the drawings. In the drawings, the same or corresponding parts are denoted by the same reference numerals, and a description thereof will not be repeated.

### Configuration of Analysis System

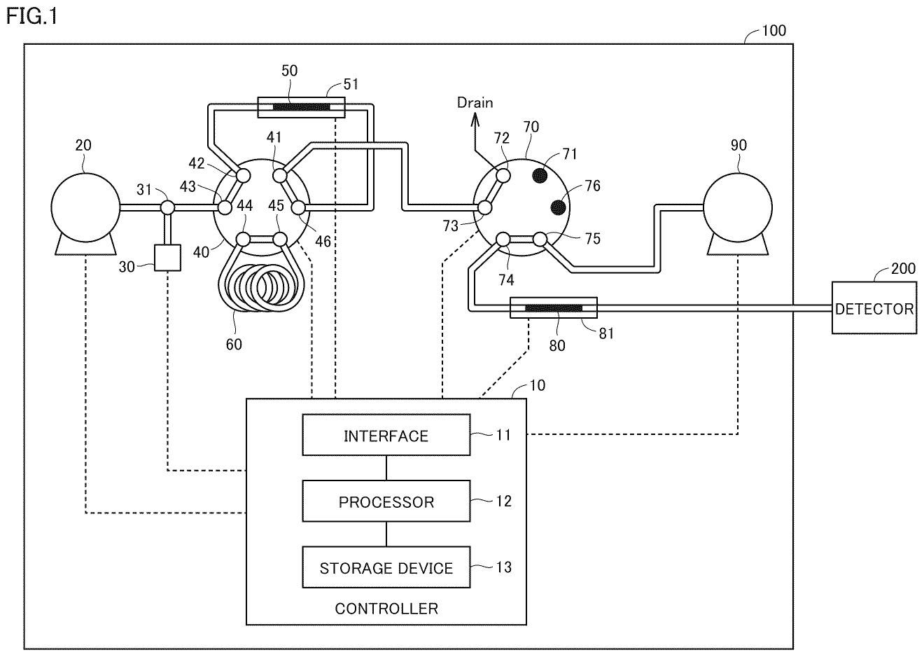

FIG. 1 is a schematic configuration diagram of an analysis system 100 according to an embodiment of the present disclosure.

As shown in FIG. 1, the analysis system 100 includes a controller 10, a first liquid-sending unit 20, a sampler 30, a first switching valve 40, a first column 50, a loop 60, a second switching valve 70, a second column 80, and a second liquid-sending unit 90.

In one implementation, the analysis system 100 has a configuration for implementing two-dimensional chromatography. More specifically, a Solid Phase Extraction (SPE) column is used as the first column 50, and a column for separating one or more components primarily separated from the first column 50 is used as the second column 80. Note that what is implemented by the analysis system 100 is not limited to two-dimensional chromatography, as long as it is multidimensional chromatography.

The controller 10 is an example of a computer that controls the operation of the analysis system 100. The controller 10 includes an interface 11, a processor 12, and a storage device 13. In one implementation, the controller 10 controls the operation of the analysis system 100 by the processor 12 executing a program non-transitorily stored in the storage device 13. The processor 12 may execute a program non-transitorily stored in a recording medium detachable from the controller 10. The interface 11 is realized by a communication interface (for example, a network card). The processor 12 communicates with other elements in the analysis system 100 (the first liquid-sending unit 20, the sampler 30, etc.) via the interface 11, and also communicates with devices outside the analysis system 100.

The first liquid-sending unit 20 supplies a plurality of types of containers to the first column 50 or the loop 60 via the first switching valve 40. More specifically, the first liquid-sending unit 20 includes a plurality of tanks that store each of a plurality of types of solutions. Each tank has a plurality of pumps that send the solution contained in the tank to the first switching valve 40.

An introduction port 31 is provided in the flow path between the first liquid-sending unit 20 and the first switching valve 40. The sampler 30 supplies a sample to the flow path via the introduction port 31.

The first switching valve 40 has six ports 41 to 46. The connection mode of the ports 41 to 46 is controlled by the controller 10.

The first column 50 is housed in a column oven 51. The environment (for example, temperature) inside the column oven 51 is controlled by the controller 10.

The loop 60 is an example of a storage unit for storing a fluid. In the analysis system 100, the shape of the storage unit is not limited to a loop shape as shown as the loop 60.

The second switching valve 70 has six ports 71 to 76. The connection mode of the ports 71 to 76 is controlled by the controller 10. Port 72 is connected to a drain. That is, the fluid introduced into the port 72 is discharged to a recovery container within the analysis system 100. Ports 71 and 76 are closed.

The second column 80 is housed in a column oven 81. The environment (for example, temperature) inside the column oven 81 is controlled by the controller 10.

The second liquid-sending unit 90 supplies a plurality of types of solutions to the second column 80 via the second switching valve 70. More specifically, the second liquid-sending unit 90 includes a plurality of tanks that store each of a plurality of types of solutions. Each tank has a plurality of pumps that send the solution contained in the tank to the second switching valve 70.

The analysis system 100 is connected to a detector 200. An example of the detector 200 is a mass spectrometer. In one implementation, a component fractionated from a sample in the analysis system 100 is sent to the detector 200, and the detector 200 performs a mass analysis of the component.

### Operation of Analysis System

In the analysis system 100, the connection mode of the ports in the first switching valve 40 and the second switching valve 70 is controlled according to the type of operation, and the ON/OFF of the supply from the first liquid-sending unit 20 and the second liquid-sending unit 90 and the type of solution to be supplied are controlled.

The first liquid-sending unit 20 houses tanks for three types of solutions (a washing liquid, a mobile phase for trapping the sample in the first column 50, and a high-concentration organic solvent for primary separation of the sample). The mobile phase for trapping the sample in the first column 50 is an example of a trapping solvent. The high-concentration organic solvent for primary separation of the sample is an example of an elution solvent.

The second liquid-sending unit 90 houses tanks for two types of solutions (a first mobile phase and a second mobile phase). The controller 10 causes the second liquid-sending unit 90 to supply the two types of solutions while changing their ratio, thereby performing gradient elution using the second column 80.

The specific types of the washing liquid, trapping solvent, elution solvent, first mobile phase, and second mobile phase can be appropriately determined by the user based on the situation in which the analysis system 100 is used (for example, components expected to be included in the sample).

The terms “position 0” and “position 1” are used for the port connection modes of the first switching valve 40 and the second switching valve 70.

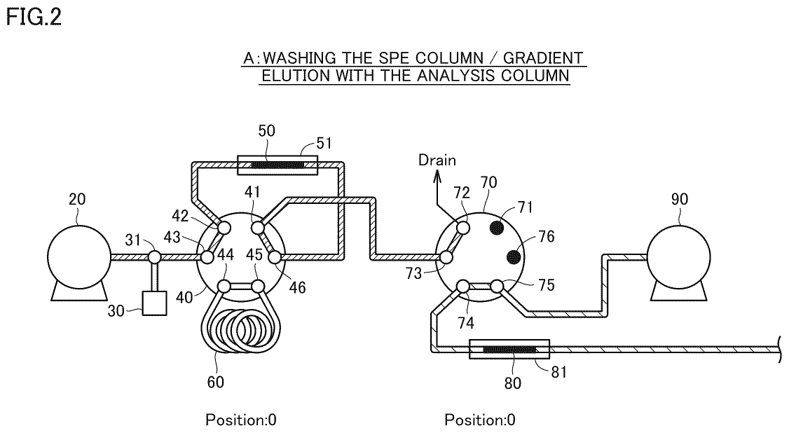

In “position 0” of the first switching valve 40, as shown in FIG. 2, port 42 is connected to port 43, port 44 is connected to port 45, and port 46 is connected to port 41.

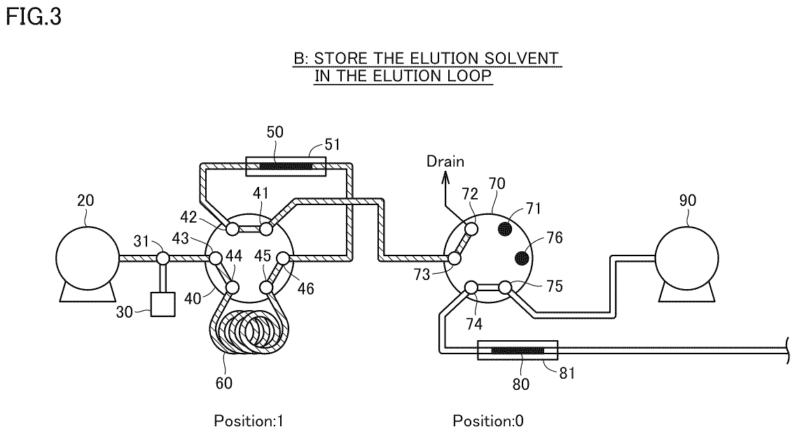

In “position 1” of the first switching valve 40, as shown in FIG. 3, port 41 is connected to port 42, port 43 is connected to port 44, and port 45 is connected to port 46.

In “position 0” of the second switching valve 70, as shown in FIG. 2, port 72 is connected to port 73, port 74 is connected to port 75, and port 76 is connected to port 71.

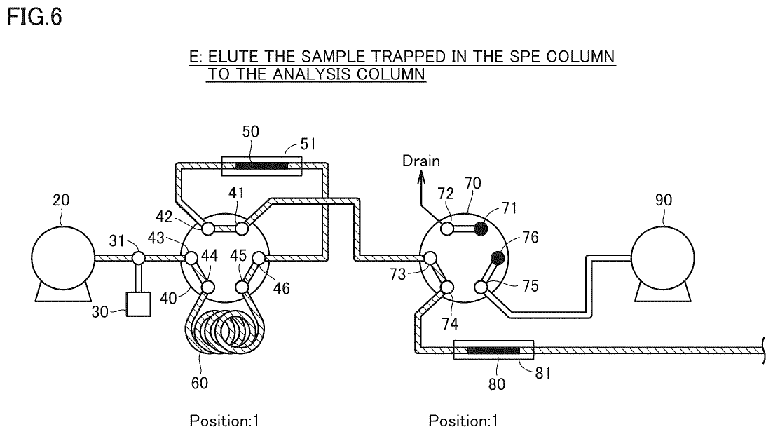

In “position 1” of the second switching valve 70, as shown in FIG. 6, port 71 is connected to port 72, port 73 is connected to port 74, and port 75 is connected to port 76.

Hereinafter, an example of the operation of the analysis system 100, namely initialization and analysis, will be described with reference to FIGS. 2 to 8.

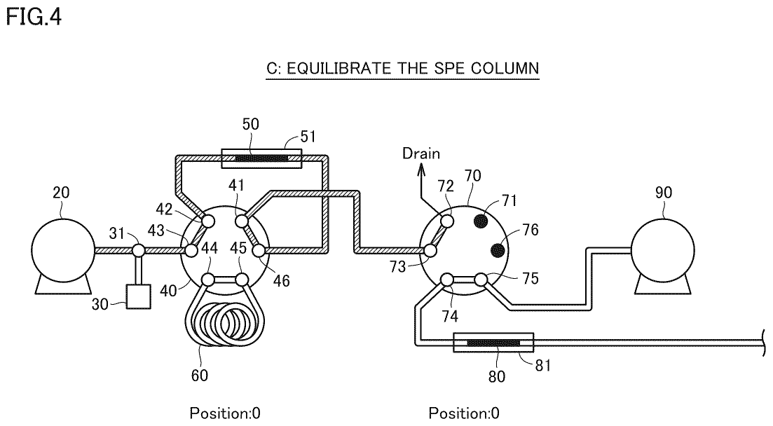

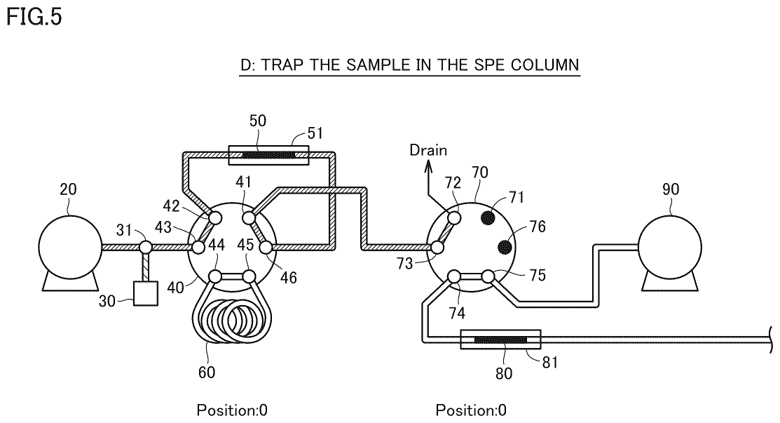

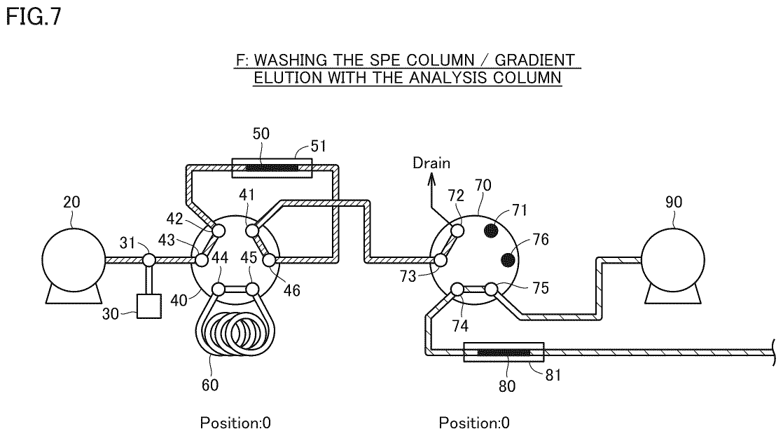

FIG. 2 is a diagram for explaining the operation during period A. FIG. 3 is a diagram for explaining the operation during period B. FIG. 4 is a diagram for explaining the operation during period C. FIG. 5 is a diagram for explaining the operation during period D. FIG. 6 is a diagram for explaining the operation during period E. FIG. 7 is a diagram for explaining the operation during period F.

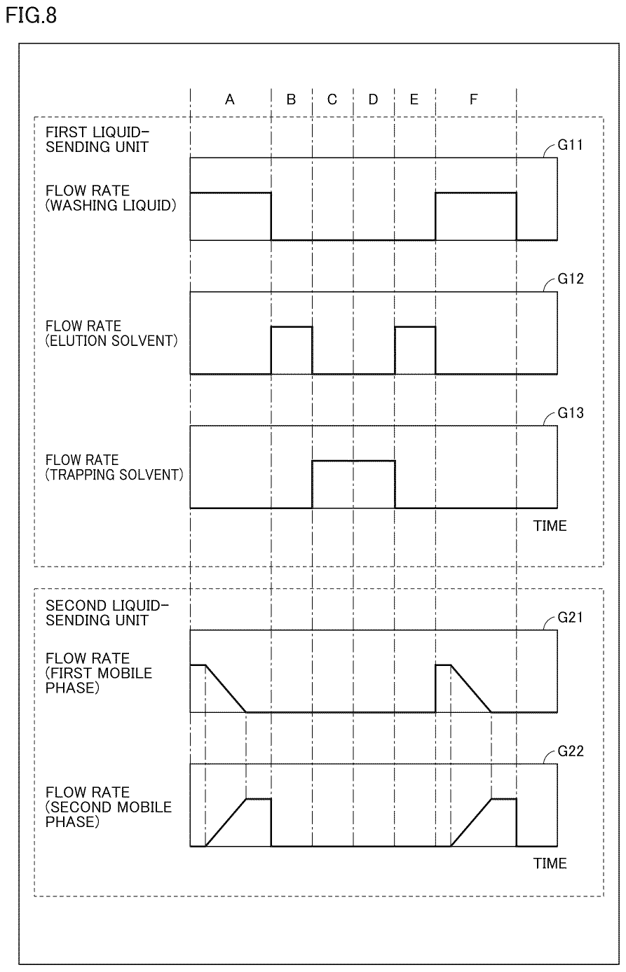

FIG. 8 is a diagram for explaining the operations of the liquid-sending unit 20 and the second liquid-sending unit 90 during periods A to F. More specifically, FIG. 8 shows the supply amounts (flow rates) of the washing liquid (graph G11), the elution solvent (graph G12), and the trapping solvent (graph G13) by the first liquid-sending unit 20 during periods A to F. Further, FIG. 8 shows the supply amounts (flow rates) of the first mobile phase (graph G21) and the second mobile phase (graph G22) by the second liquid-sending unit 90 during periods A to F.

### <Initialization>

In one implementation, the operations of periods A to C are performed during initialization.

(Period A) During period A, the first column 50 (SPE column) is washed, and gradient elution is performed in the second column 80 (analysis column).

More specifically, during period A, as shown in FIG. 2, the first switching valve 40 and the second liquid-sending unit 90 are set to “position 0”,

As shown in FIGS. 2 and 8, the controller 10 causes the first liquid-sending unit 20 to supply the washing liquid to the first switching valve 40. The washing liquid is discharged from the first switching valve 40 to the drain via the first column 50 and the second switching valve 70. This washes the first column 50.

Further, the controller 10 causes the second liquid-sending unit 90 to supply a solution to the second column 80. This washes the second column 80. The solution supplied to the second column 80 may be the first mobile phase or the second mobile phase.

As shown in FIG. 8, in the washing of the second column 80 during period A, the controller 10 may cause the second liquid-sending unit 90 to supply two types of solutions to the second switching valve 70 such that their ratio changes over time. The solution supplied to the second switching valve 70 is discharged via a divert valve (not shown) provided between the second column 80 and the detector 200. As a result, gradient elution using the second column 80 is performed, and the second column 80 is washed. In gradient elution, the ratio of the two types of solutions in the mobile phase supplied to the second column 80 changes over time. This allows a wide range of characteristic solutions to be supplied to the second column 80, and more types of foreign substances can be removed from the second column 80 in the above-mentioned washing.

### (Period B)

During period B, the elution solvent is stored in the loop 60 (elution loop).

More specifically, during period B, as shown in FIG. 3, the first switching valve 40 is set to “position 1 ” and the second switching valve 70 is set to “position 0”.

As shown in FIGS. 3 and 8, during period B, the controller 10 causes the first liquid-sending unit 20 to supply the elution solvent to the first switching valve 40. The elution solvent is stored in the loop 60.

### (Period C)

During period C, the first column 50 (SPE column) is equilibrated.

More specifically, during period C, the first switching valve 40 and the second switching valve 70 are set to “position 0”.

As shown in FIGS. 4 and 8, during period C, the controller 10 causes the first liquid-sending unit 20 to supply the trapping solvent to the first switching valve 40. As a result, the first column 50 is equilibrated by the trapping solvent.

### <Analysis>

In one implementation, the operations of periods D to F are performed during analysis.

### (Period D)

During period D, the sample is trapped in the first column 50 (SPE column).

More specifically, during period D, the first switching valve 40 and the second switching valve 70 are set to “position 0”.

As shown in FIGS. 5 and 8, during period D, the controller 10 causes the first liquid-sending unit 20 to supply the trapping solvent to the first switching valve 40, while causing the sampler 30 to introduce the sample into the introduction port 31. As a result, the sample is transported to the first column 50 and trapped in the first column 50.

### (Period E)

During period E, the sample trapped in the first column 50 (SPE column) is eluted to the second column 80 (analysis column).

More specifically, during period E, the first switching valve 40 and the second switching valve 70 are set to “position 1”.

As shown in FIGS. 6 and 8, during period E, the controller 10 causes the first liquid-sending unit 20 to supply the elution solvent to the first switching valve 40. As a result, the sample trapped in the first column 50 is primarily separated by the elution solvent. Then, at least one component constituting the sample is introduced into the second column 80.

### (Period F)

During period F, washing of the first column 50 (SPE column) and gradient elution in the second column 80 (analysis column) are performed.

More specifically, during period F, the first switching valve 40 and the second switching valve 70 are set to “position 0”.

As shown in FIGS. 7 and 8, during period F, the controller 10 causes the second liquid-sending unit 90 to supply the first mobile phase and the second mobile phase to the second switching valve 70. At this time, the ratio of the first mobile phase and the second mobile phase changes over time. As a result, the secondary elution of at least one component in the second column 80 is realized as gradient elution. The component eluted from the second column 80 is introduced into the detector 200. More specifically, by appropriately controlling the divert valve, a desired component among the components eluted from the second column 80 is selectively introduced into the detector 200.

### Processing Flow

### (Main Routine)

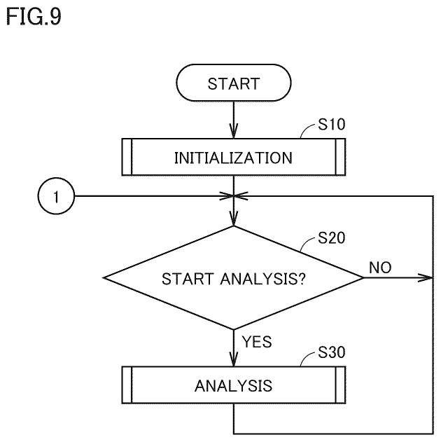

The flow of processing performed in the analysis system 100 will be described. FIG. 9 is a flowchart of an example of processing performed in the analysis system 100. In one implementation, the processing of FIG. 9 is performed in the analysis system 100 by the processor 12 executing a given program. In one implementation, the processing of FIG. 9 is started when the power of the analysis system 100 is turned on (at startup).

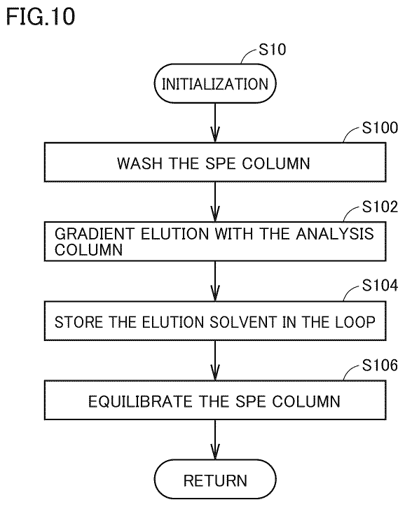

Referring to FIG. 9, in step S10, the analysis system 100 performs initialization. The details of the initialization will be described later with reference to FIG. 10.

In step S20, the analysis system 100 determines whether the timing to start the analysis has arrived. The timing to start the analysis arrives, for example, when the user performs a given operation on an input device connected to the controller 10, when the analysis system 100 receives an instruction to start the analysis, or when a reserved time for starting the analysis has arrived.

When the analysis system 100 determines that the timing to start the analysis has arrived (YES in step S20), it proceeds to step S30; otherwise (NO in step S20), it repeats the control of step S20.

### (Step S20: Initialization)

FIG. 10 is a flowchart of a subroutine of step S10 in FIG. 9.

In step S100, the analysis system 100 washes the first column 50 (SPE column). In one implementation, the washing of the SPE column is realized in the manner described with reference to FIGS. 2 and 8.

In step S102, the analysis system 100 performs gradient elution in the second column 80 (analysis column). In one implementation, the gradient elution of step S102 is realized in the manner described with reference to FIGS. 2 and 8.

In step S104, the analysis system 100 stores the elution solvent in the loop 60. In one implementation, the storage of the elution solvent is realized in the manner described with reference to FIGS. 3 and 8.

In step S106, the analysis system 100 equilibrates the first column 50 (SPE column). In one implementation, the equilibration of the SPE column is realized in the manner described with reference to FIG. 4. Thereafter, the analysis system 100 returns control to FIG. 9.

As described with reference to FIG. 10, in the initialization, washing of the SPE column, gradient elution in the analysis column, storage of the elution solvent, and equilibration of the SPE column are performed. The analysis system 100 may perform those of these that can be performed in parallel, in parallel. For example, the storage of the elution solvent does not overlap with the flow paths of the solutions for washing the SPE column, gradient elution in the analysis column, and equilibration of the SPE column. Therefore, the analysis system 100 may perform the storage of the elution solvent in parallel with at least one of washing the SPE column, gradient elution in the analysis column, and equilibration of the SPE column. This can shorten the time required for initialization.

In the analysis system 100, the equilibration of the SPE column in step S106 may be performed before the storage of the elution solvent in step S104. Note that the equilibration of the SPE column in step S106 is performed after the storage of the elution solvent in step S104.

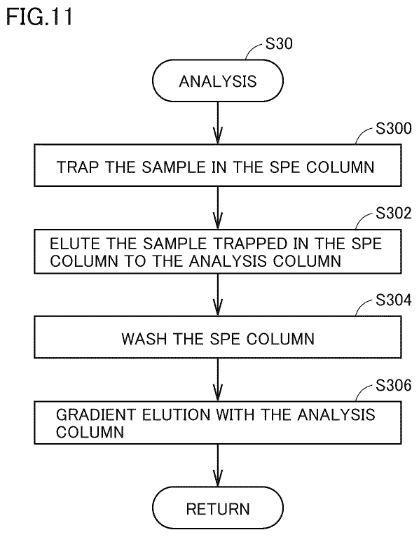

As will be described later with reference to FIG. 11, in the analysis process, the sample is first trapped in the SPE column. If the equilibration of the SPE column in step S106 is performed after the storage of the elution solvent in step S104, the analysis system 100 can proceed to analysis after the end of initialization without changing the type of solution (trapping solvent) provided by the first liquid-sending unit 20.

### (Step S30: Analysis)

FIG. 11 is a flowchart of a subroutine of step S30 in FIG. 9.

In step S300, the analysis system 100 traps the sample in the first column 50 (SPE column). In one implementation, the trapping of the sample in step S300 is realized in the manner described with reference to FIGS. 5 and 8.

In step S302, the analysis system 100 elutes the sample trapped in the first column 50 (SPE column) to the second column 80 (analysis column). In one implementation, the elution of the sample in step S302 is realized in the manner described with reference to FIGS. 6 and 8.

In step S304, the analysis system 100 washes the first column 50 (SPE column). In one implementation, the washing of the first column 50 is realized in the manner described with reference to FIGS. 7 and 8.

In step S306, the analysis system 100 performs gradient elution in the second column 80 (analysis column). In one implementation, the gradient elution of step S306 is realized in the manner described with reference to FIGS. 7 and 8. Thereafter, the analysis system 100 returns control to FIG. 9.

### (Error Handling)

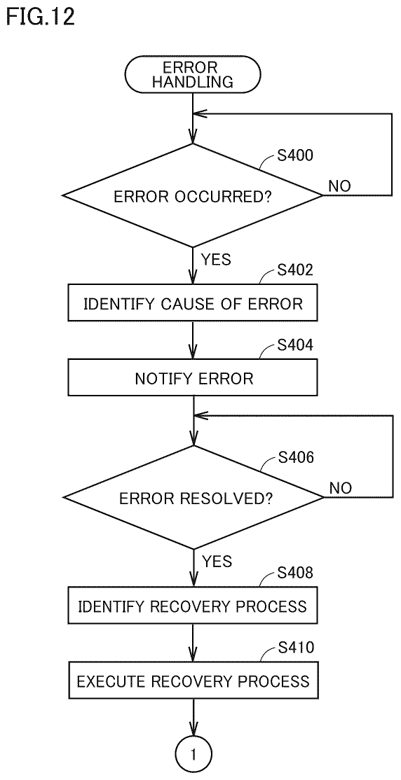

FIG. 12 is a flowchart of a process (error handling process) performed in parallel with the process of FIG. 9. In one implementation, the process of FIG. 12 is performed in the analysis system 100 by the processor 12 executing a given program.

Referring to FIG. 12, in step S400, the analysis system 100 determines whether the occurrence of an error has been detected in the analysis system 100. An example of an error in the analysis system 100 is a hardware-related and/or software-related error in the controller 10. Another example is an error in the flow path including the first switching valve 40 and the second switching valve 70. An error detection sensor is arranged in the analysis system 100. Then, an error in the flow path is detected, for example, by the fact that although the supply of solution from the first liquid-sending unit 20 or the second liquid-sending unit 90 has been started, an expected flow rate is not detected at an expected timing in the flow path of the solution.

The analysis system 100 repeats the control of step S400 until the occurrence of an error is detected in the analysis system 100 (NO in step S400), and when the occurrence of an error is detected (YES in step S400), it proceeds to step S402.

In step S402, the analysis system 100 identifies the cause of the error in the analysis system 100.

An example of the cause of the error is a shortage of a solution (at least one of the washing liquid, the elution solution, the trapping solution, the first mobile phase, or the second mobile phase). In the analysis system 100, the remaining amount of each solution is detected by a liquid level sensor or a weight sensor. The fact that the remaining amount of at least one solution has fallen below a predetermined amount is detected as an error.

Another example of the cause of the error is an abnormality in the liquid-sending pressure. In the analysis system 100, a pressure sensor is attached to the pump that sends out each solution. The fact that the detection value of the pressure sensor for at least one solution is outside a predetermined range is detected as an error.

Still another example of the cause of the error is a liquid leak. In the analysis system 100, one or more liquid leak sensors are provided on the flow path of the solution. The fact that one or more liquid leak sensors have detected a liquid leak is detected as an error.

In step S404, the analysis system 100 notifies of the error. The analysis system 100 may notify not only that an error has occurred, but also the cause and/or a method for resolving the error. More specifically, regarding a shortage of a solution, the type of the insufficient solution and/or a request for replenishment may be notified. Regarding an abnormality in the liquid-sending pressure, information identifying the pump for which the detection value of the pressure sensor was detected to be outside a predetermined range may be notified. Regarding a liquid leak, the position on the flow path of the sensor that detected the liquid leak may be notified. The notification may be performed in any manner, and may be a display, an audio output, or a combination thereof.

In step S406, the analysis system 100 determines whether the error has been resolved. The analysis system 100 may determine that the error has been resolved when it detects that the remaining amount of the solution for which a shortage was detected is equal to or greater than a predetermined amount. The analysis system 100 may determine that the error has been resolved when it detects that the detection value of the pressure sensor, which was detected to be outside a predetermined range, is within the predetermined range. The analysis system 100 may determine that the error has been resolved when it detects that the sensor that detected a liquid leak no longer detects a liquid leak.

In one implementation, when an error occurs in the analysis system 100, the error is notified, and the user performs a process to resolve the cause of the error (for example, replenishing a solution).

The analysis system 100 repeats control of step S406 until it determines that the error has been resolved (NO in step S406), and when it determines that the error has been resolved (YES in step S406), it proceeds to step S408.

In step S408, the analysis system 100 specifies the content of the recovery process of step S410, which will be described later.

In one implementation, the analysis system 100 specifies, as the content of the recovery process, something from which a part is omitted from the content constituting the initialization of step S10.

The content of the recovery process is specified based on the state of the analysis system 100. For example, when a state in which the first column 50 has been washed and the first column 50 has not been equilibrated is specified as the state of the analysis system 100, the analysis system 100 specifies, as the content of the recovery process, something from which the washing of the first column 50 (S100) is omitted from the initialization. For example, when a state in which it has been washed and equilibrated is specified as the state of the analysis system 100, the analysis system 100 specifies, as the content of the recovery process, something from which the washing of the first column 50 (S100) and the equilibration of the first column 50 (S106) are omitted from the initialization.

For example, when a state in which the supply of the mobile phase to the second column 80 has been completed is specified as the state of the analysis system 100, the analysis system 100 specifies, as the content of the recovery process, something from which the gradient elution using the second column 80 (S102) is omitted from the initialization.

For example, when a state in which the elution solvent is stored in the loop 60 is specified as the state of the analysis system 100, the analysis system 100 specifies, as the content of the recovery process, something from which the storage of the elution solvent in the loop 60 (S104) is omitted from the initialization. The analysis system 100 may include a sensor for detecting that a given amount of elution solvent is stored in the loop 60. Whether the analysis system 100 is in a state where the elution solvent is stored in the loop 60 may be determined based on the detection output of the sensor. By using such a sensor, it can be reliably detected that the analysis system 100 is not in a “state where the elution solvent is stored in the loop 60” when a sufficient amount of elution solvent is not stored in the loop 60, because the storage of the elution solvent in the loop 60 described as period B of FIG. 3 did not end normally, or the primary separation using the first column 50 described as period E of FIG. 6 did not end normally.

Note that in step S408, a plurality of states among the state related to the first column 50, the state related to the second column 80, and the state related to the loop 60 may be specified. When a state in which the first column 50 has been washed and the first column 50 has not been equilibrated, and a state in which the supply of the mobile phase to the second column 80 has been completed are specified, the analysis system 100 specifies, as the content of the recovery process, something from which the washing of the first column 50 (S100) and the gradient elution using the second column 80 (S102) are omitted from the initialization.

The content of the recovery process may be associated with the cause of the occurred error, or may be preset by the user.

In step S410, the analysis system 100 performs the recovery process. The content of the recovery process performed in step S410 has been specified in step S408. Thereafter, the analysis system 100 returns control to step S20 of FIG. 9, and returns the control of the process of FIG. 12 to step S400.

As described above with reference to FIG. 12, when an error occurs in the analysis system 100, a recovery process is performed after the error is resolved. As a result, the user is not required to instruct the analysis system 100 about the recovery process. Therefore, compared to a case where the user manually instructs the analysis system 100 of the recovery process when an error occurs, the analysis system 100 can return to a state where analysis can be resumed earlier. The content of the recovery process is specified based on the state of the analysis system 100 when the error occurred. This minimizes the time and materials (such as washing liquid) required for the recovery process.

The analysis system 100 may accept an instruction from the user as the content of the recovery process. An example of the instruction is the content that is always included in the recovery process. For example, the user can input an instruction to the analysis system 100 that the recovery process always includes the first column 50. In this case, even if the washing of the first column 50 has been completed in the analysis system 100 when an error occurs, the analysis system 100 always includes the washing of the first column 50 in the recovery process in step S404.

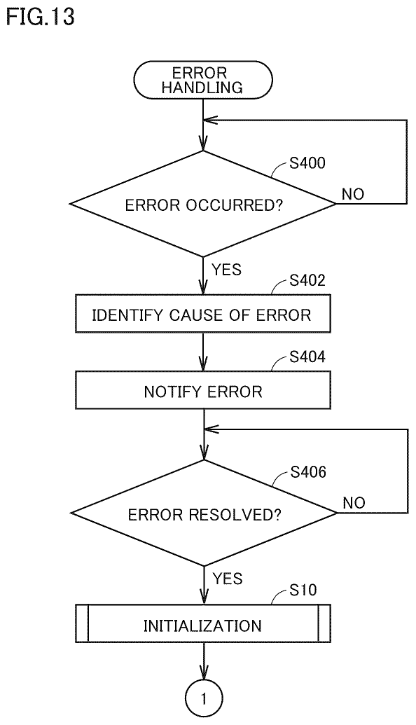

FIG. 13 is a diagram showing a modification of FIG. 12. In the example of FIG. 13, when the analysis system 100 detects that the error has been resolved in step S406, it performs the initialization of step S10. That is, in the example of FIG. 13, regardless of the state of the analysis system 100, all the steps of the initialization of step S10 are performed as the recovery process of step S410 of FIG. 12. This makes it possible to reliably make the state of the analysis system 100 constant when recovering from an error state.

### Aspects

Those skilled in the art will understand that the plurality of exemplary embodiments described above are specific examples of the following aspects.

(Item 1) An analysis system according to one aspect may comprise: a first column that traps a sample; a first supply unit that supplies one or more types of fluids to the first column, wherein the one or more types of fluids include a washing liquid, a trapping solvent for trapping the sample in the first column, and an elution solvent for primarily separating the sample trapped in the first column; a storage unit that stores the elution solvent; a second column to which one or more components primarily separated by the first column are introduced; a second supply unit that supplies a mobile phase for secondary separation to the second column; and a controller that controls the first supply unit and the second supply unit, wherein the controller, as an initialization of the analysis system, performs: washing the first column; supplying the mobile phase to the second column; storing the elution solvent in the storage unit; and equilibrating the first column with the trapping solvent.

According to the analysis system of Item 1, a technique is provided for reducing the user's burden regarding the initialization of an analysis system that implements two-dimensional chromatography.

(Item 2) In the analysis system of Item 1, the controller may perform supplying the mobile phase to the second column in parallel with at least one of washing the first column, causing the elution solvent to be trapped, and equilibrating the first column.

According to the analysis system of Item 2, the time required for initialization is shortened. (Item 3) In the analysis system of Item 1 or 2, the mobile phase may be constituted by a plurality of types of solutions, and the controller, in supplying the mobile phase to the second column, may supply the plurality of types of solutions to the second column while changing the ratio of the plurality of types of solutions over time. According to the analysis system of Item 3, impurities in the second column are more reliably removed during initialization.

(Item 4) In the analysis system of any one of Items 1 to 3, the controller may perform equilibrating the first column after storing the elution solvent.

According to the analysis system of Item 4, there is no need to change the type of fluid provided from the first liquid-sending unit for the primary separation using the first column after initialization.

(Item 5) In the analysis system of any one of Items 1 to 4, the controller may perform the initialization when an error is detected in the analysis system.

According to the analysis system of Item 5, the state of the analysis system after recovery when an error is detected becomes more reliably constant.

(Item 6) In the analysis system of any one of Items 1 to 4, the controller may perform the initialization with some steps omitted based on the state of the analysis system when an error is detected in the analysis system.

According to the analysis system of Item 6, the content of the processing when an error is detected is suppressed to the necessary minimum.

(Item 7) In the analysis system of Item 6, when the state of the analysis system is one in which the first column has been washed and the first column has not been equilibrated, the some steps may include washing the first column.

According to the analysis system of Item 7, when an error is detected and the necessity of washing the first column is low, the content of the processing for recovery from the error is suppressed to the necessary minimum.

(Item 8) In the analysis system of Item 6 or 7, when the state of the analysis system is that the first column has been washed and the first column has been equilibrated, the some steps may include washing the first column and equilibrating the first column.

According to the analysis system of Item 8, when an error is detected and the necessity of washing and equilibrating the first column is low, the content of the processing for recovery from the error is suppressed to the necessary minimum.

(Item 9) In the analysis system of any one of Items 6 to 8, when the state of the analysis system is one in which the supply of the mobile phase to the second column has been completed, the some steps may include supplying the mobile phase to the second column.

According to the analysis system of Item 9, when an error is detected and the necessity of supplying the mobile phase to the second column is low, the content of the processing for recovery from the error is suppressed to the necessary minimum.

(Item 10) In the analysis system of any one of Items 6 to 9, when the state of the analysis system is one in which the elution solvent is stored in the storage unit, the some steps may include storing the elution solvent.

According to the analysis system of Item 10, when an error is detected and the necessity of performing control for storing the elution solvent in the storage unit is low, the content of the processing for recovery from the error is suppressed to the necessary minimum.

(Item 11) A control method for an analysis system, implemented by a computer, the analysis system comprising: a first column that traps a sample; a first supply unit that supplies one or more types of fluids to the first column, the one or more types of fluids including a washing liquid, a trapping solvent for trapping the sample in the first column, and an elution solvent for primarily separating the sample trapped in the first column; a storage unit that stores the elution solvent; and a second column to which one or more components primarily separated by the first column are introduced; and a second supply unit that supplies a mobile phase for secondary separation to the second column, the control method comprising, as an initialization of the analysis system: washing the first column; supplying the mobile phase to the second column; storing the elution solvent in the storage unit; and equilibrating the first column with the trapping solvent.

According to the control method for an analysis system of Item 11, a technique is provided for reducing the user's burden regarding the initialization of an analysis system that implements two-dimensional chromatography

(Item 12) In the control method for an analysis system of Item 11, supplying the mobile phase to the second column may be performed in parallel with at least one of washing the first column, causing the elution solvent to be trapped, and equilibrating the first column.

According to the control method for an analysis system of Item 12, the time required for initialization is shortened.

(Item 13) In the control method for an analysis system of Item 11 or 12, the mobile phase is constituted by a plurality of types of solutions, and supplying the mobile phase to the second column may include supplying the plurality of types of solutions to the second column while changing the ratio of the plurality of types of solutions over time.

According to the control method for an analysis system of Item 13, impurities in the second column are more reliably removed during initialization.

(Item 14) In the control method for an analysis system of any one of Items 11 to 13,equilibrating the first column may be performed after storing the elution solvent.

According to the control method for an analysis system of Item 14, there is no need to change the type of fluid provided from the first liquid-sending unit for the primary separation using the first column after initialization.

(Item 15) The control method for an analysis system of any one of Items 11 to 14 may further comprise a step of performing the initialization when an error is detected in the analysis system,

According to the control method for an analysis system of Item 15, the state of the analysis system after recovery when an error is detected becomes more reliably constant.

(Item 16) The control method for an analysis system of any one of Items 11 to 14 may further comprise a step of performing the initialization with some steps omitted based on the state of the analysis system when an error is detected in the control method of the analysis system.

According to the control method for an analysis system of Item 16, the content of the processing when an error is detected is suppressed to the necessary minimum.

(Item 17) In the control method for an analysis system of Item 16, when the state of the analysis system is one in which the first column has been washed and the first column has not been equilibrated, the some steps include washing the first column, when the state of the analysis system is one in which the first column has been washed and the first column has been equilibrated, the some steps include washing the first column and equilibrating the first column, when the state of the analysis system is one in which the supply of the mobile phase to the second column has been completed, the some steps include supplying the mobile phase to the second column, and when the state of the analysis system is one in which the elution solvent is stored in the storage unit, the some steps may include storing the elution solvent.

According to the control method for an analysis system of Item 17, when an error is detected and the necessity of washing the first column is low, the necessity of washing and equilibrating the first column is low, the necessity of supplying the mobile phase to the second column is low, or the necessity of performing control for storing the elution solvent in the storage unit is low, the content of the processing for recovery from the error is suppressed to the necessary minimum.

(Item 18) A computer-readable recording medium non-transitorily storing a program, wherein the program, when executed by one or more processors of a computer of an analysis system, causes the computer to implement the control method of any one of Items 11 to 17.

According to the recording medium of Item 18, a technique is provided for reducing the user's burden regarding the initialization of an analysis system that implements two-dimensional chromatography.

The embodiments disclosed this time should be considered illustrative in all respects and not restrictive. The scope of the present disclosure is indicated by the claims rather than by the description of the embodiments above, and all changes that come within the meaning and range of equivalency of the claims are intended to be embraced therein.

### REFERENCE SIGNS LIST

10 Controller, 20 First liquid-sending unit, 50 First column, 60 Loop, 80 Second column, 90 Second liquid-sending unit, 100 Analysis system.

1. An analysis system, comprising: a first column that traps a sample; a first supply unit configured to supply one or more types of fluids to the first column, wherein the one or more types of fluids include a washing liquid, a trapping solvent for trapping the sample in the first column, and an elution solvent for primarily separating the sample trapped in the first column; a storage unit configured to store the elution solvent; a second column to which one or more components primarily separated in the first column are introduced; a second supply unit configured to supply a mobile phase for secondary separation to the second column; and a controller configured to control the first supply unit and the second supply unit, wherein the controller is configured to, as an initialization of the analysis system, perform: washing the first column; supplying the mobile phase to the second column; storing the elution solvent in the storage unit; and equilibrating the first column with the trapping solvent.

2. The analysis system according to claim 1, wherein the controller is configured to perform supplying the mobile phase to the second column in parallel with at least one of washing the first column, causing the elution solvent to be trapped, and equilibrating the first column.

3. The analysis system according to claim 1, wherein the mobile phase is constituted by a plurality of types of solutions, and the controller is configured to, in supplying the mobile phase to the second column, supply the plurality of types of solutions to the second column while changing a ratio of the plurality of types of solutions over time.

4. The analysis system according to claim 1, wherein the controller is configured to perform equilibrating the first column after storing the elution solvent.

5. The analysis system according to claim 1, wherein the controller is configured to perform the initialization when an error is detected in the analysis system.

6. The analysis system according to claim 1, wherein the controller is configured to, when an error is detected in the analysis system, perform the initialization with some steps omitted based on a state of the analysis system,

7. The analysis system according to claim 6, wherein when the state of the analysis system is one in which the first column has been washed and the first column has not been equilibrated, the some steps include washing the first column.

8. The analysis system according to claim 6, wherein when the state of the analysis system is one in which the first column has been washed and the first column has been equilibrated, the some steps include washing the first column and equilibrating the first column.

9. The analysis system according to claim 6, wherein when the state of the analysis system is one in which supply of the mobile phase to the second column has been completed, the some steps include supplying the mobile phase to the second column.

10. The analysis system according to claim 6, wherein when the state of the analysis system is one in which the elution solvent is stored in the storage unit, the some steps include storing the elution solvent.

11. A control method for an analysis system, implemented by a computer, the analysis system comprising: a first column that traps a sample; a first supply unit configured to supply one or more types of fluids to the first column, the one or more types of fluids including a washing liquid, a trapping solvent for trapping the sample in the first column, and an elution solvent for primarily separating the sample trapped in the first column; a storage unit configured to store the elution solvent; a second column to which one or more components primarily separated in the first column are introduced; and a second supply unit configured to supply a mobile phase for secondary separation to the second column, the control method comprising, as an initialization of the analysis system: washing the first column, supplying the mobile phase to the second column; storing the elution solvent in the storage unit; and equilibrating the first column with the trapping solvent.

12. The control method for an analysis system according to claim 11, wherein supplying the mobile phase to the second column is performed in parallel with at least one of washing the first column, causing the elution solvent to be trapped, and equilibrating the first column.

13. The control method for an analysis system according to claim 11, wherein the mobile phase is constituted by a plurality of types of solutions, and supplying the mobile phase to the second column includes supplying the plurality of types of solutions to the second column while changing a ratio of the plurality of types of solutions over time.

14. The control method for an analysis system according to claim 11, wherein equilibrating the first column is performed after storing the elution solvent.

15. The control method for an analysis system according to claim 11, further comprising a step of performing the initialization when an error is detected in the analysis system.

16. The control method for an analysis system according to claim 11, further comprising a step of, when an error is detected in the control method of the analysis system, performing the initialization with a part of the steps omitted based on a state of the analysis system.

17. The control method for an analysis system according to claim 16, wherein when the state of the analysis system is one in which the first column has been washed and the first column has not been equilibrated, the some steps include washing the first column, when the state of the analysis system is one in which the first column has been washed and the first column has been equilibrated, the some steps include washing the first column and equilibrating the first column, when the state of the analysis system is one in which supply of the mobile phase to the second column has been completed, the some steps include supplying the mobile phase to the second column, and when the state of the analysis system is one in which the elution solvent is stored in the storage unit, the some steps include storing the elution solvent.

18. A non-transitory computer-readable recording medium storing a program that, when executed by one or more processors of a computer of an analysis system, causes the computer to implement the control method according to claim 11.
